(19) United States
(12) Patent Application Publication
(10) Pub. No.: US 2002/0174174 A1
(43) Pub. Date: Nov. 21, 2002

(54) System and method for monitoring execution time of a transaction

(76) Inventors: Anupriya Ramraj, Roseville, CA (US); John Green, Rocklin, CA (US)

Correspondence Address: Hewlett-Packard Company, Intellectual Property Administration, P.O. Box 272400, Fort Collins, CO, 80527-2400, US

(21) Appl. No.: 09/833,635

(22) Filed: Apr. 13, 2001

(51) Int. Cl. G06F 15/16

(52) U.S. Cl. 709/203

(57) ABSTRACT

The present invention is directed toward providing a system for monitoring a transaction executing on a network computer, wherein the data from the monitoring process is sent to a computer other than the browser on which the transaction is executing and other than the computer from which the transaction was downloaded. Exemplary embodiments of the invention are directed toward a system and method for monitoring a transaction executing on a network computer, including the steps of linking an applet within a web page on a web server to at least one monitoring code file; sending the web page from the web server to a client browser within a network; executing the linked applet within the web page on the client browser; invoking the monitoring code file to monitor a transaction within the linked applet on the client browser; and sending data from monitoring the transaction to a measurement computer, wherein the measurement computer is a computer other than the web server.

### BACKGROUND OF THE INVENTION

1. Field of the Invention

The present invention relates generally to monitoring computer-based transactions, and more particularly, to determining the execution time of particular blocks of code executing on a network computer remote from the monitoring computer.

2. Background Information

In today's environment of networked computers, high speed communication connections, and a multitude of Internet resources, network users demand ever shorter response times to increasingly complex online transactions. Today's network users demand almost instantaneous response to their queries, whether the requested transaction is a complex search on a multi-million line database or an online loan request that requires a credit check and verification against bank lending standards.

Users who experience what they consider unreasonably slow response times to their online queries are less likely to be satisfied with their use of a particular online transaction or web site and are less likely to return to the transaction or site, especially if alternate resources and sites are available. Correspondingly, online transaction developers are driven to streamline their transactions, not only to please their end users and encourage their return usage but also to minimize unnecessary overhead within each transaction, thousands of which may be occurring at any given moment. Transaction developers and developers of network components monitor the actual performance of their network transactions and components in actual usage to best determine whether their efforts at efficiently streamlining their products have been effective.

Accordingly, it would be desirable to provide a system and method for monitoring the actual execution times of selected network transactions, wherein the monitoring can be accomplished without interfering with the actual transaction users and wherein the evaluation of the monitored execution times can be performed without impacting the processing or communications of the targeted network transactions.

### SUMMARY OF THE INVENTION

The present invention is directed to a system for monitoring a transaction executing on a network computer, wherein the data from the monitoring process is sent to a computer other than the browser on which the transaction is executing and other than the computer from which the transaction was downloaded. Exemplary embodiments are directed toward a system and method for monitoring a transaction executing on a network computer, including the steps of accessing a web page from a web server, wherein the web page includes at least one block of processing code for executing a transaction; updating the web page by inserting instructions in the web page, wherein said instructions comprise a function for monitoring the transaction; and storing the updated web page on the web server.

Additional embodiments include inserting instructions comprising start and stop flags proximate to the transaction to be monitored. The inserted instructions can further comprise a call instruction linking the block of code to a file comprising monitoring instructions, whereas the monitoring instructions file is stored on the web server and a web server page tag of the transaction is modified to reference the monitoring instructions file.

An alternative embodiment is directed to a system and method for monitoring a transaction executing on a network computer, including sending a web page from a web server to a client browser within a network; executing an applet within the web page on the client browser, wherein the applet includes at least one link to a monitoring code file; invoking the linked monitoring code file to monitor a transaction within the linked applet on the client browser; and sending data generated from monitoring the transaction to a measurement computer, wherein the measurement computer is a computer other than the web server.

Additional embodiments include web pages containing one or more applets and applets containing one or more transactions to be monitored. Invoking the monitoring code file includes capturing data associated with the execution of the transaction on the client browser. The monitored transaction data can include one or more data items selected from a list consisting of transaction start and stop time, the time zone in which the transaction is executed, and the operating system of the client browser. The monitored transaction data is stored and evaluated on the measurement computer independently from the processing of the web page on the client browser.

A further embodiment is directed to a system and method for monitoring a transaction executing on a network computer, including downloading transaction code from a first computer to be processed on a second computer; executing the downloaded transaction code on the second computer; invoking a monitoring function, wherein transaction execution data associated with the executing transaction is captured by the monitoring function; and sending the transaction execution data from the second computer to a third computer, wherein the first, second, and third computers are remote from each other.

### BRIEF DESCRIPTION OF THE DRAWINGS

These and other objects and advantages of the present invention will become more apparent and more readily appreciated to those skilled in the art upon reading the following detailed description of the preferred embodiments, taken in conjunction with the accompanying drawings, wherein like reference numerals have been used to designate like elements, and wherein:

FIG. 1 shows a block diagram of components of a system for implementing monitoring code and links to java class files within the applets of a web page;

FIG. 2 shows a flow chart of an exemplary method for implementing monitoring code and links to java class files within the applets of a web page; and

FIG. 3 shows a block diagram of the primary components of a transaction monitoring system configured in accordance with an exemplary embodiment of the present invention.

### DETAILED DESCRIPTION OF THE PREFERRED EMBODIMENTS

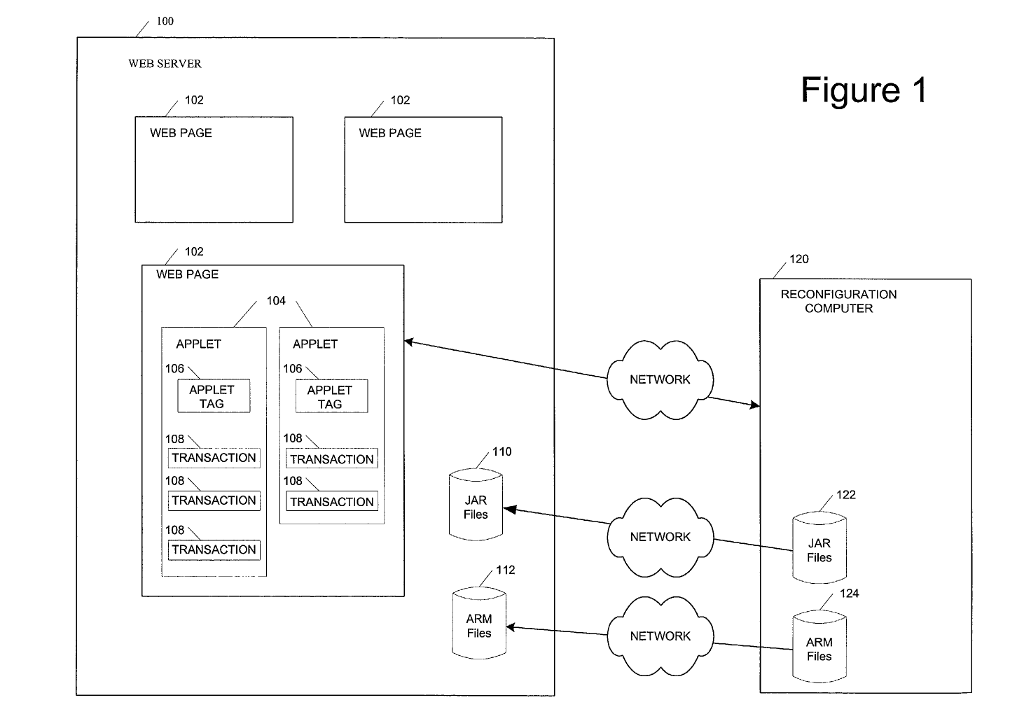

FIG. 1 shows a block diagram of a system for monitoring a transaction executing on a network computer in accordance with an exemplary embodiment of the present invention. As is well known in the art, web pages 102 to be invoked by client browsers are stored on web servers 100, waiting to be called by any number of client browsers. Each web page 102 can contain one or more applets 104, with each applet 104 comprising a finite set of instructions designed to execute a particular transaction 108 or series of transactions 108. Within the spirit of the present invention, any and all web page-based applet transactions 108 can be monitored, with the results of the monitoring transmitted from the client browser to a network computer or server other than the web server 100 storing and originating the pages 102 to the browser. Exemplary embodiments can provide real time monitoring of transactions 108 for subsequent evaluation and possible streamlining and can also perform the monitoring, storage, and evaluation of the transaction execution data without impacting the performance of or load on the web server 100. Additionally, the present invention has the advantage of being able to monitor transactions executing on network computers that are outside the realm of ownership or management control of the particular monitoring entity. For example, monitoring code can be applied to pages built by company A on a network server. An unrelated party, B, can access the web pages and execute the web page transactions on B's browser, with the transaction monitoring data being uploaded to a measurement computer under the control or management of company C, all without increasing the load on the web server.

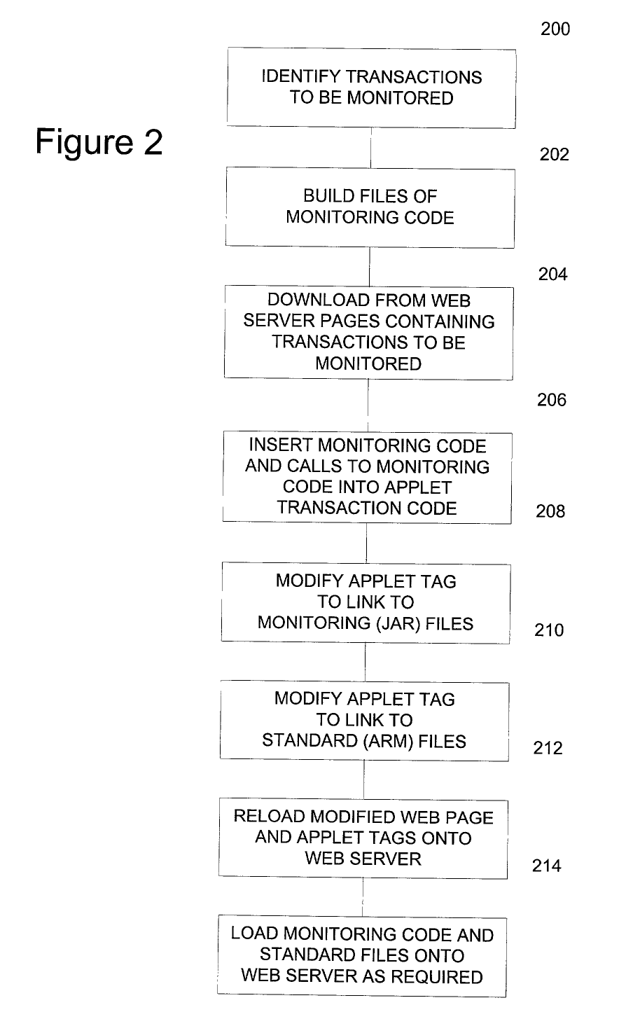

FIG. 2 shows a flow chart of an exemplary process for adding monitoring code and java call links to applets that include a transaction to be monitored. Referring to both FIGS. 1 and 2, transactions within existing applets in web pages stored on the web server are identified to be monitored at step 200. Monitoring code files are built at step 202 to provide the various monitoring functions desired, whether the monitoring is transaction execution time, the time zone in which the transaction is executing on a client browser, the operating system of the client browser, or any other desired property or characteristic associated with the applet being monitored or with one or more applets being executed at a client browser. These monitoring code files are consolidated as object-based java classes into a JAR file 122 accessible by a reconfiguration computer 120. Some of these monitoring functions can be provided through code conforming to the Application Response Measurement Application Programming Interface standard (ARM API), as discussed below regarding ARM files 112 and step 210. The aforementioned reconfiguration computer 120 can be any processor accessible by a developer or monitoring personnel for the insertion of calls and monitoring code applets, JAR files 110, and ARM files 112 and can include the web server 120.

Each web page 102 containing transactions 108 to be monitored is downloaded at step 204 from the web server 100 to the reconfiguration computer 120 and each applet 104 in the web page 102 is checked to determine whether the applet 102 includes a transaction 108 to be monitored. If a targeted transaction 108 is identified within the applet 104, monitoring code and/or calls to monitoring code is inserted at step 206 within the applet transaction code to be monitored. If, for example, the transaction information to be monitored is execution time, calls to ARM monitoring code can be inserted at the beginning and the end of the transaction code to capture start and stop time. If other transaction-related information is to be monitored and captured, such as the time zone in which the transaction is executing, a corresponding call or code can be inserted within the transaction code to invoke or perform the appropriate monitoring function. The aforementioned calls provide a communication link or branching function between the applet code and the monitoring code stored in a JAR file 122/110 and/or an ARM file 124/112 to efficiently provide the desired monitoring function with minimal modification of the existing code of the transaction. Of course, preexisting code already included in the applet can simply be designated to identify the start and/or stop of the applet transaction code to be monitored, or any other technique can be used to denote the transactions to be monitored without detracting from the inventive features of the present invention.

Below is an example of a monitoring code snippet which routes monitored time data to the page within the browser for eventual uploading to a monitoring, or measurement, computer:

public static synchronized void sendAppletTransactionArrayToScript (String[] postArray)
{

Object [] fnCallArray = new Object[2];
//“ inputAppletTransationArray” is the Javascript function
//that channels data to the measurement server
fnCallArray[0] = newString(“inputAppletTransactionArray”) ;
fnCallArray[1] = postArray;
m_methodCall.invoke(m_WindowScriptObject,fnCallArray) ;

}

At step 208 the tag 106 for the applet is modified to include a reference to the JAR file 110. While FIG. 1 shows the tag 106 to be separate from the transaction 108, alternate embodiments of the invention can include the tag 106 within the transaction 108 and actually embedded in the code of the transaction 108. Once all the applets 104 containing targeted transactions 108 within a web page 102 have been modified, and/or designated in any similar fashion to denote the targeted transaction, and the applets 104 have been recompiled, the modified web page 102 is reloaded onto the web server 100 at step 212. If the JAR file 122/110 has not been loaded onto the web server 100, it is transmitted to the server at step 214 for storage on the web server 100 as a JAR file 110 linked through the applet tag 106 to the applet 104. As new monitoring functions are identified, new monitoring code may have to be designed and added to the JAR file 122, in which case the JAR file 110 on the web server 100 is replaced with an updated JAR file 122 including the new or updated java classes. In the alternative, multiple JAR files 122/110 can be loaded onto and maintained on the web server 100, or onto any location associated with the web server 100 and known to the web server 100, with the applet tag 106 modified during this reconfiguration process to point to the JAR file 110 containing the appropriate monitoring code.

The monitoring code and calls to monitoring code can comply with present and future protocol standards for monitoring the performance of java applets, including the ARM API standard discussed above. However, the present invention is not limited to compliance with the ARM API standard, although compliance with conventional standards can be used to, for example, simplify application of the present invention across networks, including the Internet. The conventions implemented by these standards, such as the code or javascript to extract the system start time upon encountering or invoking a start call or flag, are stored in a library accessible by the reconfiguration computer, shown in FIG. 2 as an ARM Files library 124. While only a single ARM file 124 is shown, any number of conventional standards can be implemented within the design of the present invention, with the code necessary to implement the standards residing in a common or in separate libraries or data bases 124. The applet tag 106 for the applet 104 containing a transaction 108 that is to be monitored according to a system standard is modified at step 210 to point to the appropriate convention library 112, and the appropriate library 124/112 is loaded onto the web server 100 at step 214 in a manner similar to the storage of the JAR files 122/110 as discussed above.

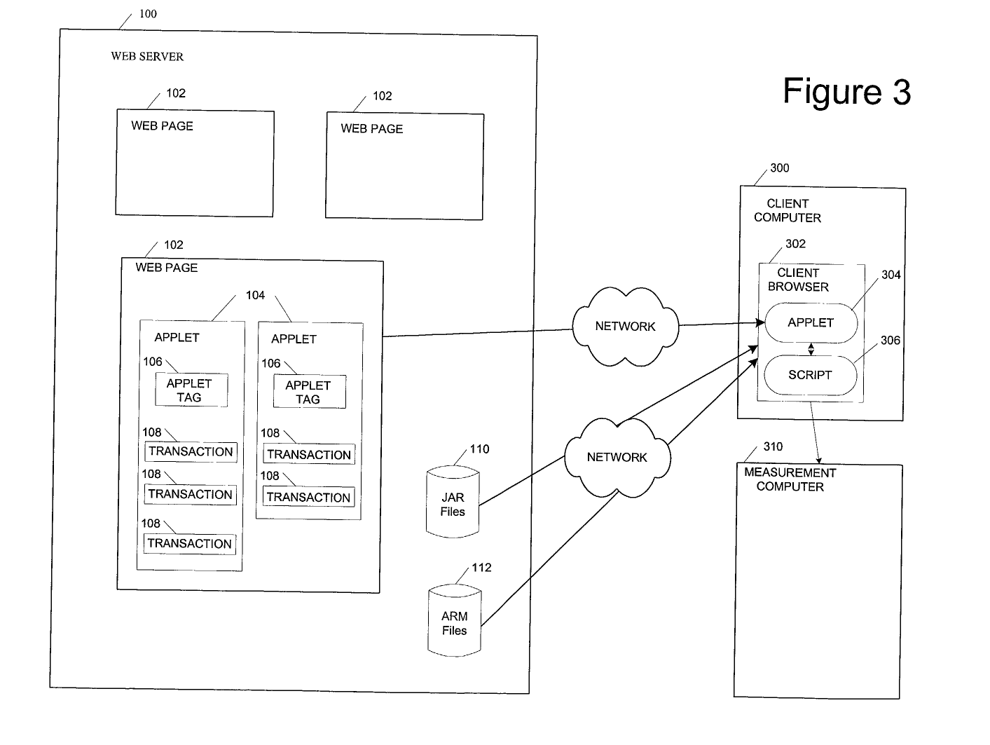

Referring now to FIG. 3, details of an exemplary monitoring process of the present system will be described. A user (web client) operating a computer 300 connected to a network invokes a browser 302 to access network features, including Internet web sites, available to the user. For example, the user can enter the Universal Resource Locator (URL) of a desired web site, and the browser transmits an inquiry across the network to locate the network web server 100 containing the web page 102 of the desired site. In response, the web server 100 sends the desired web page 102 to the client browser 302. The web page 102 can, for example be comprised of one or more applets 104, blocks of code in Dynamic Hypertext Markup Language (DHTML), or any other blocks of code, each of which can include one or more transactions 108 to actually perform the processing or function desired by the user.

The client browser 302, either dynamically or upon user query, invokes an applet 104/304 of the received web page 102. The applet 104 queries its applet tag 106 to link to any required files 110 or 112, from which the applet 104 may draw code or data. The applet 104/304 begins processing its code within the client browser 302, with the code actually comprising one or more discrete transactions 108 to perform finite functions. Upon encountering monitoring code inserted in the transaction code of the applet 104/304, the browser 302 executes the code as part of the transaction, capturing, storing, and/or uploading monitoring information as requested. Upon encountering a call to monitoring code residing in a file or library, the browser 302 utilizes the applet tag 106 to link to the appropriate library or data base 110 and/or 112 from which to extract the code by which the monitoring function is performed. For example, the browser 302 can link to the JAR files 110 to obtain monitoring code that captures the system time for the start of the transaction. The monitoring code then issues a call to a javascript routine 306 that picks up the data captured by the monitoring code and subsequently uploads the monitoring data to a measurement computer 310. The link between the applet 304 and the javascript 306 comprises a “live connect” within the web page that permits the capture of transaction data and ultimate retention of the data on a non-web server computer 310.

As an example of a web-based application utilizing the present invention, a user may access the web page 102 of a bank with the intent of transferring finds. Upon receiving the web page 102 at the client computer 300, the client browser 302 displays the web page 102 to the user, who selects the funds transfer option on the web page 102. The selection of the funds transfer feature causes the browser 302 to invoke the applet 104/304 associated with this feature and initiates a transaction to display a query screen to the user asking for the account number of the account from which the finds are to be drawn, the account number of the account in which the funds are to be deposited, and the amount of funds to be transferred. The bank may be interested in knowing how long the transfer transaction takes to execute once the user has entered the required information and, correspondingly, has inserted a call in the applet code where the transaction determines the three required pieces of information have been provided and a call in the applet code where the transaction receives confirmation that the transfer has been completed.

At each monitoring point in the code encountered by the browser 302 while processing the applet code, the browser 302 either links to the appropriate JAR 110 and/or ARM 112 file to locate and execute the appropriate code, or executes the code that has been inserted during the reconfiguration process discussed above associated with FIGS. 1 and 2. At each such monitoring point, data can be obtained (such as start time) and can either be stored until another monitoring event is encountered or can be output to the measurement computer 310. Although evaluation of the monitored data can be performed on the client computer 300, the processing of the monitored data can be performed entirely, or in part, at the measurement computer 310. For example, any portion or all of the data can be downloaded to the measurement computer 310 from the client computer 300 so that all monitoring calculations and evaluations can be performed on the measurement computer 310 to minimize processing drain on the client computer 300 and to preserve more processing resources for the client browser 302. This can affect the response time visible to the user without impacting the load on the web server 100.

Although preferred embodiments of the present invention have been shown and described, it will be appreciated by those skilled in the art that changes may be made in these embodiments without departing from the principle and spirit of the invention, the scope of which is defined in the appended claims and their equivalents.

What is claimed is:

1. A system for monitoring a transaction executing on a network computer, comprising:
a read unit accessing a web page from a web server, wherein the web page includes at least one block of processing code for executing a transaction;
an update unit updating the web page by inserting instructions in the web page, wherein said instructions comprise a function for monitoring the transaction; and
a storage unit storing the updated web page on the web server.

2. The system according to claim 1, wherein the inserted instructions comprise a call instruction linking the at least one block of code to one or more files comprising monitoring instructions.

3. The system according to claim 1, wherein the inserted instructions comprise a call instruction providing a data communication link both within the web page and to a computer remote from the web server.

4. The system according to claim 3, further comprising:
a second storage unit storing the monitoring instructions file on the web server; and
a second update unit modifying a web server page tag of the transaction to be monitored to reference the monitoring instructions file.

5. A system for monitoring a transaction executing on a network computer, comprising:
a first transmission unit sending a web page from a web server to a client browser within a network;
a processor executing an applet within the web page on the client browser, wherein the applet includes at least one link to a monitoring code file;
a monitoring unit invoking the monitoring code file to monitor a transaction within the applet on the client browser; and
a second transmission unit sending data generated from monitoring the transaction to a measurement computer, wherein the measurement computer is a computer other than the web server.

6. The system according to claim 5, wherein the web page can contain one or more applets and each applet can contain one or more transactions to be monitored.

7. The system according to claim 5, wherein the monitoring unit further captures data associated with the execution of the transaction on the client browser.

8. The system according to claim 5, wherein the monitored transaction data includes one or more data items selected from a list consisting of transaction start and stop time, the time zone in which the transaction is executed, and the operating system of the client browser.

9. The system according to claim 5, wherein the monitored transaction data is stored and evaluated on the measurement computer independently from the processing of the web page on the client browser.

10. A system for monitoring a transaction executing on a network computer, comprising:
an association unit linking an applet within a web page on a web server to at least one monitoring code file;
a first transmission unit sending the web page from the web server to a client browser within a network;
a processor executing the linked applet within the web page on the client browser;
a monitoring unit invoking the monitoring code file to monitor a transaction within the linked applet on the client browser; and
a second transmission unit sending data from monitoring the transaction to a measurement computer, wherein the measurement computer is a computer other than the web server.

11. A system for monitoring a transaction executing on a network computer, comprising:
a first transmission unit downloading transaction code from a first computer to be processed on a second computer;
a processor executing the downloaded transaction code on the second computer;
a monitor unit capturing transaction execution data associated with the executing transaction; and
a second transmission unit sending the transaction execution data from the second computer to a third computer, wherein the first, second, and third computers are remote from each other.

12. A method for monitoring a transaction executing on a network computer, comprising the steps of:
accessing a web page from a web server, wherein the web page includes at least one block of processing code for executing a transaction;
updating the web page by inserting instructions in the web page, wherein said instructions comprise a function for monitoring the transaction; and
storing the updated web page on the web server.

13. The method according to claim 12, wherein the inserted instructions comprise a call instruction linking the at least one block of code to a file comprising monitoring instructions.

14. The method according to claim 12, wherein the inserted instructions comprise a call instruction providing a data communication link both within the web page and to a computer remote from the web server.

15. The method according to claim 14, further comprising the steps of:
storing the monitoring instructions file on the web server; and
modifying a web server page tag of the transaction to be monitored to reference the monitoring instructions file.

16. A method for monitoring a transaction executing on a network computer, comprising the steps of:
sending a web page from a web server to a client browser within a network;
executing an applet within the web page on the client browser, wherein the applet includes at least one link to a monitoring code file;
invoking the linked monitoring code file to monitor a transaction within the linked applet on the client browser; and
sending data generated from monitoring the transaction to a measurement computer, wherein the measurement computer is a computer other than the web server.

17. The method according to claim 16, wherein the web page can contain one or more applets and each applet can contain one or more transactions to be monitored.

18. The method according to claim 16, wherein the step of invoking the monitoring code file includes capturing data associated with the execution of the transaction on the client browser.

19. The method according to claim 16, wherein the monitored transaction data includes one or more data items selected from a list consisting of transaction start and stop time, the time zone in which the transaction is executed, and the operating system of the client browser.

20. The method according to claim 16, wherein the monitored transaction data is stored and evaluated on the measurement computer independently from the processing of the web page on the client browser.

21. A method for monitoring a transaction executing on a network computer, comprising the steps of:
linking an applet within a web page on a web server to at least one monitoring code file;
sending the web page from the web server to a client browser within a network;
executing the linked applet within the web page on the client browser;
invoking the linked monitoring code file to monitor a transaction within the linked applet on the client browser; and
sending data generated from monitoring the transaction to a measurement computer, wherein the measurement computer is a computer other than the web server.

22. A method for monitoring a transaction executing on a network computer, comprising the steps of:
downloading from a first computer transaction code to be processed on a second computer;
executing the downloaded transaction code on the second computer;
invoking a monitoring function, wherein transaction execution data associated with the executing transaction is captured by the monitoring function; and
sending the transaction execution data from the second computer to a third computer, wherein the first, second, and third computers are remote from each other.
